(19) United States
(12) Patent Application Publication
(10) Pub. No.: US 2008/0084057 A1
(43) Pub. Date: Apr. 10, 2008

(54) Calculator with integrated memo pad holder

(76) Inventors: Merrick Falkenstein, Markham (CA); Kenneth Liu, Hong Kong (HK)

Correspondence Address: MEREK, BLACKMON & VOORHEES, LLC, 673 S. WASHINGTON ST., ALEXANDRIA, WV, 22314, US

(21) Appl. No.: 11/439,972

(22) Filed: May 25, 2006

(30) Foreign Application Priority Data
Apr. 21, 2006 (CA) 2,544,450

(51) Int. Cl. B42D 17/00

(52) U.S. Cl. 281/44

(57) ABSTRACT

An electronic calculator comprising a housing having an upper portion and a lower portion rotatably secured together by a hinge portion such that the housing has an open and a closed position. When the housing is closed the upper portion is generally adjacent to and generally covers the lower portion and when the housing is open the upper portion is rotated away from the lower portion. A calculator module is positioned on one of the upper and lower portions. The other of the upper and lower portions includes a memo pad holder. The memo pad holder comprises a cavity within the other of the upper and lower portions and has an upper opening to allow a memo or note pad to be releasably received therein. A finger recess is in communication with the cavity and provides access to individual sheets of paper comprising a memo or note pad received within the cavity and assists in the removal of individual sheets of paper therefrom. The housing generally confines the side and bottom surfaces of a memo or note pad received within the cavity to prevent damage thereto. When the housing is in its closed position it provides protection to the upper surface of a memo or note pad received within the cavity.

### FIELD OF THE INVENTION

This invention relates generally to the field of calculators, and more particularly to a calculator having an integrated memo pad holder.

### BACKGROUND OF THE INVENTION

Hand-held or portable electronic calculators are widely available and are used on a daily basis by large numbers of people. Such calculators have been designed in a variety of different shapes and configurations to both facilitate their use and to ease in transportation. While electronic calculators greatly simplify the task of performing mathematical calculations, in many instances it is still desirable to utilize a pen or pencil and a piece of paper for calculation purposes, or to record information relevant to a particular calculation or an answer that has been derived through the use of an electronic calculator. For that reason many people commonly carry with them an electronic calculator, a memo pad and a pen or a pencil.

For purposes of convenience others have proposed the use of various book or sleeve-like structures which are designed to hold both a calculator and a memo pad. Unfortunately, such existing products are rather clumsy, tend to be bulky and are not easily concealable when not being used. In many instances such devices also do not provide a sturdy surface for taking notes and integrated paper or memo pads are left unprotected, to the point that they can readily become damaged, dirty or torn.

### SUMMARY OF THE INVENTION

The invention therefore provides a calculator having a integrated memo pad holder that overcomes many of the deficiencies of similar devices that have been previously proposed. The invention provides a calculator having an integrated memo pad holder that presents a user with a sturdy surface for taking notes while operating the calculator, and at the same time provides a means to protect a note or memo pad secured thereto.

Accordingly, in one of its aspects the invention provides an electronic calculator comprising a housing having an upper portion and a lower portion rotatably secured together by a hinge portion such that said housing has an open and a closed position, when in said closed position said upper portion generally adjacent to and generally covering said lower portion, when said housing is in said open position said upper portion rotated away from said lower portion; a calculator module positioned on one of said upper and said lower portions, said calculator module having a keypad, a display, a central processing unit and a power source, the other of said upper and said lower portions not containing said calculator module including a memo pad holder, said memo pad holder comprising a cavity within said other of said upper and said lower portions of said housing, said cavity having an upper opening to allow a memo or note pad to be releasably received therein; and, a finger recess in communication with said cavity, said finger recess providing access to individual sheets of paper comprising a memo or note pad received within said cavity and assisting in the removal of individual sheets of paper therefrom, said housing generally confining the side and bottom surfaces of a memo or note pad received within said cavity to prevent damage thereto, when said housing is in said closed position with said upper portion generally adjacent to and generally covering said lower portion said housing providing protection to the upper surface of a memo or note pad received within said cavity.

Further aspects and advantages of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show the preferred embodiments of the present invention in which:

FIG. 1 is an upper side perspective view of a preferred embodiment of the present invention in its closed position;

FIG. 2 is an upper side perspective view of the embodiment of the invention shown in FIG. 1 in an open position;

FIG. 3 is a plan view of the embodiment of the invention shown in FIG. 2;

FIG. 4 is a side elevational view of the embodiment of the invention shown in FIG. 2 that includes a partial cross-section detailing a locking mechanism that retains the device in its closed position;

FIG. 5 is a side elevational view opposite to that of FIG. 4, wherein the device has its integrated writing instrument removed from an internal receptacle; and,

FIG. 6 is a bottom view of the device shown in FIG. 1.

### DESCRIPTION OF THE PREFERRED EMBODIMENT

The present invention may be embodied in a number of different forms. However, the specification and drawings that follow describe and disclose only some of the specific forms of the invention and are not intended to limit the scope of the invention as defined in the claims that follow herein.

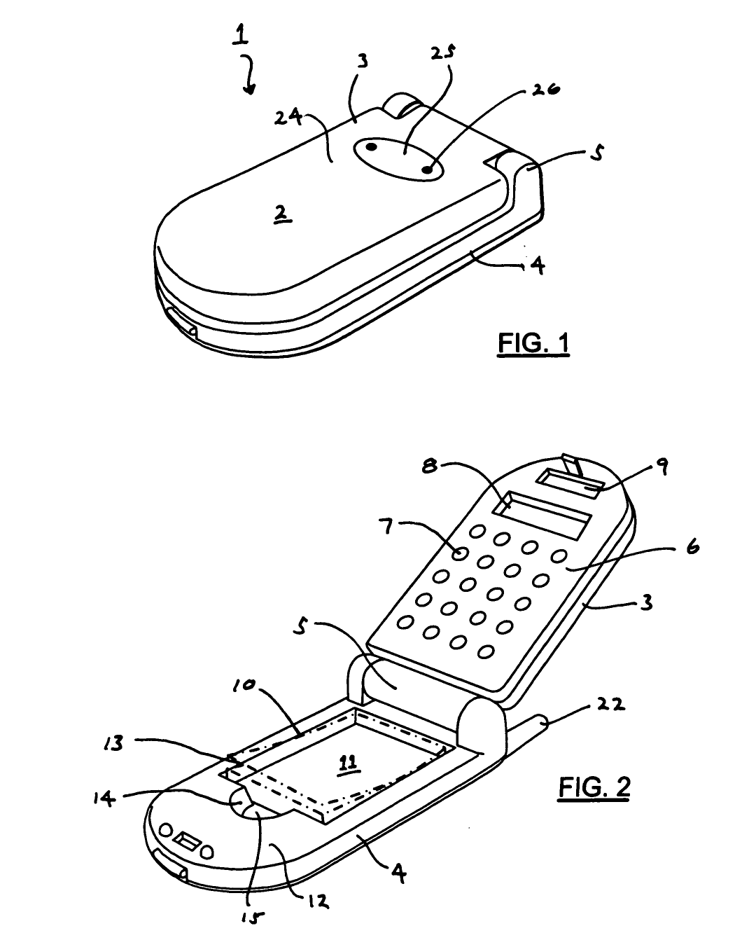

In the attached drawings an electronic calculator constructed in accordance with one of the preferred embodiments of the present invention is identified by reference numeral 1. Calculator 1 is generally comprised of a housing 2 which is formed from an upper portion 3, a lower portion 4 and a hinge portion 5 that rotably secures the upper and lower portions together. Hinge portion 5 effectively provides housing 2 with an open and a closed position, shown generally in FIGS. 1 and 2, respectively. When housing 2 is in its closed position (as in FIG. 1) upper portion 3 is generally adjacent to and generally covers lower portion 4. On the other hand, when housing 2 is in its open position (as shown in FIG. 2) upper portion 3 has been rotated away from lower portion 4 such that the upper portion is no longer adjacent and no longer covers the lower portion. Of course, it will be appreciated that the housing may be configured so as to have a wide variety of other degrees of “openness” aside from the two specific positions shown in FIGS. 1 and 2.

Housing 2 further includes a calculator module 6 that is positioned on one of upper portion 3 and lower portion 4. In the attached drawings calculator module 6 is shown positioned upon upper portion 3, however, in an alternate embodiment the calculator module could be positioned on lower portion 4 of housing 2. Typically calculator module 6 will include a keypad 7, a central processing unit (not shown), a display 8 and a power source which may include a battery and/or a photo electric or solar cell 9. With reference to FIG. 2, it will be noted that the other of the upper and lower portions of the housing that does not contain calculator module 6 (in this case lower portion 4) includes a memo pad holder 10.

In the embodiment of the invention shown in the attached drawings memo pad holder 10 is comprised of a cavity 11 within the upper surface 12 of lower portion 4 of housing 2. Cavity 11 is dimensioned to permit a memo or note pad 13 (as shown in ghost outline in FIG. 2) to be releasably secured therein. The memo pad may be secured within cavity 11 through the use of an adhesive, two-sided tape or with the aid of any of a wide variety of mechanical fasteners. Typically the memo pad will be comprised of a number of sheets of paper that are glued along one edge so that individual sheets are releasably secured to one another, as is common in the prior art. The depth of cavity 11 is preferably such that it permits the receipt of a memo pad containing a desired number of sheets of paper with the top of the pad at generally the same elevation or slightly below the upper surface of lower portion 4.

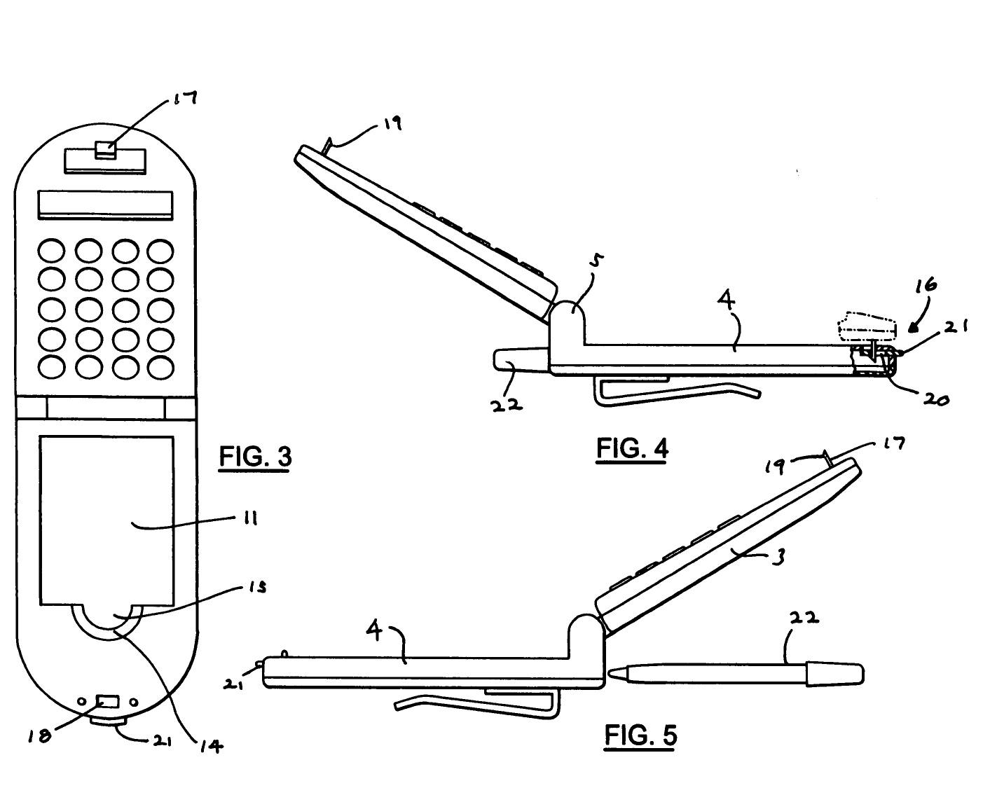

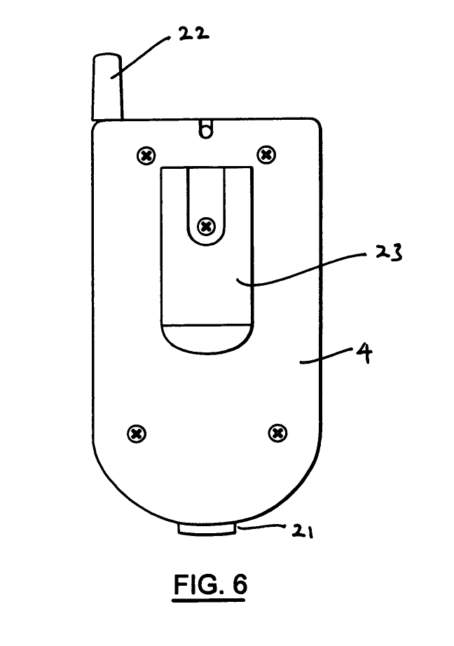

In the preferred embodiment of the invention electronic calculator 1 further includes a finger recess 14 in communication with cavity 11 that facilitates or enhances access to individual sheets of paper forming a memo pad received within the cavity. With reference to FIGS. 2 and 3, in the embodiment shown finger recess 14 is generally semi-circular in shape and intersects cavity 11 along its lower edge. The bottom 15 of finger recess 14 preferably intersects the bottom surface of cavity 11 in a fashion that allows an individual to readily and easily access the last or bottom sheets of paper in a memo pad received in the cavity. This permits the individual to grasp the last or lower sheets of paper so that they may be readily removed from cavity 11 when desired.

As will be apparent from an examination of the attached Figures and an understanding of the invention, the sides and bottom surfaces of cavity 11 will help to confine a memo pad received within the cavity and help to prevent damage to the memo pad and its individual sheets of paper when housing 2 is in its open position. When the housing is in its closed position upper portion 3 will be generally adjacent to and generally covering lower portion 4, thereby providing protection to the upper surface of the memo pad. Accordingly, it will be appreciated that the described structure provides a means to securely retain and protect a memo pad when the pad is not in use, while at the same time providing a mechanism that allows access to the memo pad when desired and further provides a means by which individual papers of the memo pad can be easily grasped and removed.

In order to help retain housing 2 in its open position and to permit unobstructed access to both calculator module 6 and memo pad holder 10, in one embodiment of the invention hinge portion 5 includes a spring that biases the housing to its open position. Hinge portion 5 may also be designed to limit the rotational movement of upper portion 3 away from lower portion 4 to less than 180 degrees such that when housing 2 is in its fully open position the upper and lower portions of the housing form an obtuse angle therebetween. It has been found that when in such a configuration, housing 2 will generally fit easily within the hand of an individual in a manner that facilitates access and use of both calculator module 6 and a memo pad received in cavity 11.

Where hinge portion 6 includes a spring that biases housing 2 to its open position, electronic calculator 1 will preferably further include a locking clasp 16 that has an engaged position to secure the upper and lower portions of the housing together and to prevent relative rotation therebetween. Locking clasp 16 will also have a disengaged position that permits the spring in hinge portion 5 to rotate upper portion 3 away from lower portion 4, thereby placing housing 2 in its open position. It will also be appreciated by those skilled in the art that it will be desirable to incorporate locking clasp 16 into electronic calculator 1 even in situations where hinge portion 5 does not include a spring. Doing so will allow the housing to be held in its closed position when being transported and when not in use, and will prevent unwanted rotational movement of the upper and lower portions.

Locking clasp 16 may take any one of a wide variety of different mechanical structures ranging from a simple hook and loop type fastening mechanism to a more complex structure formed from a plurality of different component parts. In the attached drawings locking clasp 16 is comprised generally of a locking tab 17 that is received within a slot 18 when housing 2 is in its closed position. As shown in FIGS. 4 and 5, locking tab 17 includes a shoulder 19 that may be received beneath a slide plate 20 to secure tab 17 within slot 18 and retain housing 2 in its closed position. Slide plate 20 is preferably biased to a position that retains shoulder 19 thereunder, however, may be moved to a position that permits locking tab 7 to be withdrawn from slot 18 through the application of external force applied to a button 21 extending outwardly from housing 2. That is, a force applied to button 21 causes slide plate 20 to move and to thereby release shoulder 19 such that locking tab 17 is free to be withdrawn from slot 18. Relative rotational movement of upper and lower portion 3 and 4 will then be possible.

With reference once again to the attached drawings, in the embodiment shown electronic calculator 1 further includes a writing instrument 22 that may be comprised of a pen, pencil, marker or similar device. Writing instrument 22 may be secured or otherwise fastened to the exterior of housing 2. Alternately, and as shown in the attached Figures, housing 2 may be equipped with an internal receptacle that permits the receipt and retention of writing instrument 22 therein. In the particular form of the invention that is shown in the attached drawings housing 2 is in the general shape of a flip cellular telephone. In this configuration a portion of writing instrument 22 preferably extends outwardly from housing 2 when the writing instrument is received within the receptacle and the outwardly extending portion of the writing instrument is in the general shape of an antennae.

To further enhance the use of electronic calculator 1, housing 2 may include a belt clip 23 to permit the housing to be releasably secured to the belt of a user. It will, however, be appreciated by those skilled in the art that clip 23 may also be used to secure calculator 1 to a variety of other items including pads of paper, folders, vehicle sun visors, etc. Further, the upper surface 24 of upper portion 3 of housing 2 may contain a removable insert 25 upon which advertising, logos, trademarks or other indicia may be applied. The removability of insert 25 is such that during manufacturing housing 2 may be constructed as described above and thereafter may have any desired insert attached to it, depending upon the end use of the product or the customer to which it is being directed. In the attached drawings insert 25 is secured to housing 2 through the use of a pair of screws 26, however, other fastening mechanisms, including adhesives, could also be used.

It is to be understood that what has been described are the preferred embodiments of the invention and that it may be possible to make variations to these embodiments while staying within the broad scope of the invention. Some of these variations have been discussed while others will be readily apparent to those skilled in the art.

We claim:

1. An electronic calculator comprising:
a housing having an upper portion and a lower portion rotatably secured together by a hinge portion such that said housing has an open and a closed position, when in said closed position said upper portion generally adjacent to and generally covering said lower portion, when said housing is in said open position said upper portion rotated away from said lower portion;
a calculator module positioned on one of said upper and said lower portions, said calculator module having a keypad, a display, a central processing unit and a power source, the other of said upper and said lower portions not containing said calculator module including a memo pad holder, said memo pad holder comprising a cavity within said other of said upper and said lower portions of said housing, said cavity having an upper opening to allow a memo or note pad to be releasably received therein; and,
a finger recess in communication with said cavity, said finger recess providing access to individual sheets of paper comprising a memo or note pad received within said cavity and assisting in the removal of individual sheets of paper therefrom,
said housing generally confining the side and bottom surfaces of a memo or note pad received within said cavity to prevent damage thereto, when said housing is in said closed position with said upper portion generally adjacent to and generally covering said lower portion said housing providing protection to the upper surface of a memo or note pad received within said cavity.

2. The electronic calculator as claimed in claim 1 wherein said upper portion of said housing has upper and lower surfaces, said calculator module received within said lower surface of said upper portion.

3. The electronic calculator as claimed in claim 2 wherein said lower portion of said housing has upper and lower surfaces, said memo pad holder received within said upper surface of said lower portion.

4. The electronic calculator as claimed in claim 1 wherein said upper portion of said housing has upper and lower surfaces, said memo pad holder received within said lower surface of said upper portion.

5. The electronic calculator as claimed in claim 4 wherein said lower portion of said housing has upper and lower surfaces, said calculator module received within said upper surface of said lower portion.

6. The electronic calculator as claimed in claim 1 wherein said hinge includes a spring that biases said housing to said open position.

7. The electronic calculator as claimed in claim 6 including a locking clasp having an engaged and a disengaged position, when in said engaged position said locking clasp securing said upper and said lower portion of said housing together, when in said disengaged position said locking clasp permitting said spring to rotate said upper portion of said housing away from said lower portion thereby placing said housing in said open position and providing access to said calculator module and said memo pad holder.

8. The electronic calculator as claimed in claim 7 wherein said housing includes a receptacle permitting the receipt and retention of a writing instrument therein.

9. The electronic calculator as claimed in claim 1 wherein said housing includes a belt clip.

10. The electronic calculator as claimed in claim 1 wherein said upper portion of said housing has upper and lower surfaces, said upper surface of said upper portion containing a removable insert to permit the application of advertising, logos, trademarks or other indicia to said housing.

11. The electronic calculator as claimed in claim 1 wherein said housing is in the shape of a flip cellular telephone, said electronic calculator further including a writing instrument partially received within a receptacle within said housing such that a portion of said writing instrument extends outwardly from said housing, said portion of said writing instrument extending outwardly from said housing in the shape of an antennae.
